(19) United States
(12) Patent Application Publication
(10) Pub. No.: US 2007/0166138 A1
(43) Pub. Date: Jul. 19, 2007

(54) Truck Mounted Multifunction Lifting System and Method

(76) Inventor: Brady B. Brooks, Montgomery, TX (US)

Correspondence Address: KENNETH L. NASH, P.O. BOX 680106, HOUSTON, TX, 77268-0106, US

(21) Appl. No.: 11/623,360

(22) Filed: Jan. 16, 2007

Related U.S. Application Data
(60) Provisional application No. 60/759,860, filed on Jan. 18, 2006.

(51) Int. Cl. B60P 1/04

(52) U.S. Cl. 414/471

(57) ABSTRACT

A collapsible electrical or hydraulic system mountable in the rear of a truck for lifting and other functions. The system is compatible with other common uses of pick-up trucks. It is operated from within the cab of the truck, standing outside the pick-up truck bed, or remotely. The system operates in various modes and with various tools. The lifting system is collapsible to a low-profile and allows the use of the pick-up truck for towing a “gooseneck” trailer. Multiple attachments include, but are not limited to, a fork lift, hay bale spear, hay bale unroller, pallet forks, man-lift cages, dump bucket, drilling attachment, and/or a vehicle recovery platform, such as the towing/lifting functions of a tow truck.

This application claims priority from U.S. Provisional Patent Application No. 60/759,860, filed Jan. 18, 2006.

### BACKGROUND OF THE INVENTION

1. Field of the Invention

The present invention relates generally to truck mounted lifting systems and, more particularly, to a removable and/or collapsible lifting system mountable within a truck bed that may be used for functions such as, but not limited to, powered handling, transporting, distributing, loading and unloading of a load.

2. Description of the Background

The prior art provides examples of lifting systems, but these devices have shortcomings for usage with trucks and especially pick-up trucks. Prior art devices often interfere with common practical uses of pick-up trucks and/or truck trailers. Prior art devices are also typically limited in the types of lifting and/or other functions that can be performed.

Patents in the general field of lifting systems are shown as follows:

U.S. Pat. No. 6,817,820, issued Nov. 16, 2004, to Ackerman et al, discloses a preferred embodiment of a bed assembly for flat bed trucks that has a square bale retriever at the rear of the flat bed that includes a pair of lift arms adapted to grasp a bale by its opposite ends and lift it up off the ground and onto a transverse feeder located at the front of the bed. Once deposited on the feeder, a pusher engages one end of the bale and pushes the bale along the feeder to progressively advance successive flakes of the bale into a discharging position off the remote end of the feeder. The bale can thus be progressively distributed one flake at a time, the frequency of flake discharge being controlled by the operator in the cab of the truck. Alternative embodiments for pushers for engaging and advancing the bale toward the discharge point are disclosed. The feeder may be utilized separate from the bed assembly and includes a ramp that causes the bale to move up an incline during feeding operations.

U.S. Pat. No. 5,662,449, issued Sep. 2, 1997, to Krinhop, discloses a lifting device (10) that provides for lifting bales (14) of material. In broad terms, the lifting device (10) comprises a lifting arm assembly (12), and a winch assembly (16). The lifting arm assembly (12) includes a pair of lifting arms (22,24) pivotally coupled with an axle (26), and a closing arm (28). The lifting arms (22,24) are shiftable between spread and drawn positions, and between lowered and raised positions. A linkage assembly (86) intercouples the lifting arms (22,24), and is adapted for shifting the lifting arms (22,24) between the spread and drawn positions. The closing arm (28) is pivotally attached to the axle (26), and is adapted to engage the linkage assembly (86) for shifting the lifting arms (22,24). The closing arm (28) is shiftable between a bale-disengaging position where the lifting arms (22,24) are in the spread position, and a bale-engaging position where the lifting arms (22,24) are in the drawn position. The closing arm (28) is also shiftable toward a bale-transporting position for rotating the axle (26) to shift the lifting arms (22,24) toward the raised position. The winch assembly (16) is adapted for selectively shifting the closing arm (28) between the bale-disengaging and bale-transporting positions.

U.S. Pat. No. 4,023,690, issued May 17, 1977, to Goode, discloses an object for loading and unloading of a type having a framework adapted to be connected to a truck bed. A track is connected to the framework, the track having a forward horizontal portion and rearward inclined portion. A frame having forklift members connected perpendicularly to the bottom thereof has four wheels adapted to ride on the track. Two of the wheels ride primarily on the inclined portion of the track and the other two wheels ride primarily on the forward horizontal portion of the track. The frame is movably mounted on the track so that in one position the forklift members are horizontal and can be driven under an object to be transported. A winch is connected to the framework and has a cable which connects to a pulley on the top of the frame for selectively pivoting the frame and forklift members and for pulling such frame and thereby an object on the forklift members onto the track and thereby onto a truck bed. The winch is further utilized for unloading the object by releasing the frame and allowing it to roll down the track by gravity to one position and then to pivot, also by the force of gravity, into an unloading position.

U.S. Pat. No. 4,722,651, issued Feb. 2, 1988, to Antal, discloses a device for attachment to the rear of a pickup truck as a replacement for the rear bumper that includes a transverse frame member which is pivotally mounted on brackets carried on the chassis. The frame member carries a pair of arms each of which is pivoted at an outer end of the frame member and extends across the frame member in a folded position with an outer stub portion extending outwardly and around the end of the frame member to define ends of the bumper. Hydraulic rams can pivot the frame member about a horizontal axis and can pivot the arms about vertical axes at the outer ends of the frame member. Flanges extending from the rear face of the frame member confine and receive the arms and define a compartment for a hitch pin.

U.S. Pat. No. 4,412,768, issued Nov. 1, 1983, to Bauer et al, discloses a hydraulically powered unit which serves as a rear truck bumper and as a bale carrier for large cylindrical hay bales. The unit includes a pair of stationary end bumper sections and a pivotal center bumper section having a pair of sockets for receiving bale piercing spears. A rigid frame secures the bumper to the truck at the customary location for the rear bumper. The center bumper section can be pivoted by hydraulic cylinders in order to load an impaled bale into the truck bed for transport and to unload the bale back onto the ground. Spring loaded locking plates hold the spears in the sockets and can be released to permit removal of the spears when they are not needed to handle bales.

U.S. Pat. No. 6,394,732, issued May 28, 2002, to Sweezey, discloses a bale handling device including a bale frame and an attachment mechanism for attaching the device to a vehicle such that the bale frame can be raised and lowered. The bale frame includes a support beam as a primary bale support, a pair of arms connected with the support beam, and a pair of bale engaging members connected with the arms as a secondary bale support. The secondary bale support is located relative to the primary bale support such that when a bale is positioned within the bale frame and lifted by the device it is supported by both the primary bale support and the secondary bale support and its center of gravity is located between the primary bale support and the secondary bale support.

U.S. Pat. No. 5,890,864, issued Apr. 6, 1999, to Sloan, discloses a load lifting scissors lift assembly, as an attachment for the three-point-hitch of a farm tractor, which utilizes a scissors-action, hinged, expandable linkage. The Heavy-duty Hay Scissors Lift assembly contains one pair of crossed lever arms, each connecting to a vertical load engaging structure (in the case described, a hay spike arrangement), the first through intermediate connection to a variable length middle arm, or third arm, and the second through direct connection to the lowest point of the load engaging structure. The assembly is constructed to multiply the lift of the tractor's lift arms. The expanding linkage is capable of lifting standard six-foot high round bales of hay or other material, outwards and upwards and placing one bale on top of another. The Heavy-duty Hay Scissors Lift is constructed without the use of additional hydraulics, to minimize the cost of materials, complexity, maintenance, and redundancy (a tractor having lift arms already has hydraulics). An alternate embodiment of the invention is constructed with the replacement of the intermediate member with a hydraulic cylinder which adds the ability to release the load while elevated for deposit over a fence, rail, or hay guard structure.

U.S. Pat. No. 4,091,946, issued May 30, 1978, to Kraeft et al, discloses cable reels that are loaded, unloaded, transferred or otherwise handled relative to the flatbed of a vehicle by a pivotally mounted lift assembly, which includes a main rotary shaft having two or more extended lift arms rigidly attached in a generally U-shaped configuration. The main rotary shaft, when attached along one edge of the flat bed, is capable of pivoting through 180 degree rotation by hydraulic rams or the like, and the lift arms include an arrangement for securing the cargo outwardly of the shaft with hydraulically actuated gripper finger arrangements. Arrangement of a plurality of lift assemblies in tandem so that the extremities of the lift arms are on intersecting arcs enables the cargo to be lifted from the ground surface onto the flatbed and transferred to different selected positions. Power winches appropriately positioned or peripheral engagement of cable reel containers allow rotary cargo for cable reel winding or unwinding.

U.S. Pat. No. 3,625,380, issued Dec. 7, 1971, to Anderson, discloses a series of three transversely spaced lift arms that are mounted on a common transverse rock shaft carried at the rear end of a portable frame for movement between a first position projected rearwardly and downwardly from the frame to a second position projected upwardly and forwardly above the frame. The center one of the lift arms is releasably secured to the rock shaft at a position spaced equidistantly from each of the outer lift arms to provide for a small reel being loaded by the center lift arm and one of the outer lift arms. On removal of the center lift arm a large reel is loaded by the outer two arms.

U.S. Pat. No. 6,761,524, issued Jul. 13, 2004, to Chabanas et al, discloses load handling equipment that enables a vehicle to put down on the ground or pick up a load such as a dumpster and to tip the load, which is provided on a front face with a lifting bar. The equipment includes a deformable and tilting handling arm which can assume, in addition to a transport position and a putting down on the ground or picking up position, a tipping position in which a hook interengages with the lifting bar on the load on being pivoted by a tilting actuator about a transverse pivot axis at the rear of the equipment and spaced downwardly from the longitudinal section of the handling arm. The transverse rear pivot axis is behind and under the side members of the chassis frame of the vehicle and the frame of the equipment has an L-shaped profile with a first branch on top of the side members of the chassis frame. An upper portion of the second branch is against the rear of the side members.

U.S. Pat. No. 3,848,758, issued Nov. 19, 1974, to Carter, discloses a hydraulic truck bed that comprises a platform, loading forks fastened upstandingly from the rearwardmost terminal end of the platform and a movable headboard which may be selectively actuated against a container.

U.S. Pat. No. 5,651,653, issued Jul. 29, 1997, to Bablo, discloses a hayroll handling device that comprises a hayroll or bale spear secured to the snowplow headgear mounted on a light truck or the like. The snowplow blade and associated lifting arm are removed from the headgear, which is permanently mounted on the vehicle. The first end of the spear is then pivotally mounted to the headgear at the pivotal attachment point for the removed blade lifting arm, and the spear is also secured to the upper end of the plow blade lift hydraulic cylinder or ram, which remains with the headgear after removal of the blade and lift arm. The vehicle and attached spear may then be used to impale a large hayroll or the like, with the existing plow blade lifting hydraulics being used to lift the spear and impaled roll or bale, so the vehicle may be driven to transport the roll to a livestock feeding station or other area as desired. The spear may be provided in any practicable length with a pointed tip at the distal second end, in order to provide optimal penetration of the hayroll. The spear may be made from solid rod or hollow tubular stock, in round, rectangular, or other cross sectional shapes, as desired. The device provides further seasonal utility for the snowplow hydraulic mechanism and structure, and is easily installed, as normally the plow blade is removed from the vehicle during the spring, summer, and fall in any case.

U.S. Pat. No. 4,578,008, issued Mar. 25, 1986, to Gleason, discloses a lifting and loading apparatus installed on the front of a load-bearing vehicle for lifting and loading a hay bale or like load located forward of the vehicle by moving it up and over the vehicle cab to position it on the trailer bed. A pivoting lift frame assembly is movably mounted to a stationary frame assembled to the vehicle. The pivoting frame assembly carries load arms which are movable toward and away from one another in side-to-side relationship relative to the vehicle. The load arms are equipped with articulated gripping members that can come together and grip the hay bale. The lift frame assembly is moved to the overhead position with the load arms carrying the hay bale to deposit the hay bale on the vehicle load bed.

U.S. Pat. No. 2,824,655, issued Feb. 25, 1958, to Harbers, relates to dump trucks, particularly designed, although not necessarily, for transporting rubbish, and having a front end loader of the type which comprises a loading element in the form of a bucket, scoop, or fork, which is mounted on the front ends of a pair of lifting arms that are pivoted on opposite sides of the truck frame for swinging movement so that the loading element can be swung from a loading position at the forward end of the truck upwardly and rearwardly over the truck cab to a dumping position directly above the dump body. By repeated operations of the loader in this manner, the dump body can be ultimately filled with rubbish whence, the truck is driven to a location and the rubbish dumped from the body by tilting the latter.

U.S. Pat. No. 2,121,121, issued Jun. 21, 1938, to Dempster, relates to transporting and dumping vehicles that has for its object to improve the construction and operation of the same, whereby the cost of construction and the cost of operation may be decreased, and the general operation improved.

Consequently, there remains a long felt need for more versatile and improved lifting systems for specific use with a pick-up truck. Those skilled in the art have long sought and will appreciate the present invention that addresses these and other problems.

### SUMMARY OF THE INVENTION

It is an object of the present invention to provide an improved lifting system.

It is yet another object of the present invention to provide a lifting system that is mountable to a pick-up.

It is yet another object of the present invention to provide a lifting system that does not interfere with other common functions of a pick-up truck to which it may be attached.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the present invention provides a power lifting system for a pick-up truck to engage items to be lifted, which comprises one or more components such as, for example, a sub-structure securable with respect to the pick-up truck bed. The substructure may comprise beams sized and spaced apart to permit access to sixty percent or more of the pick-up truck bed when the sub-structure is secured with respect to the pick-up truck bed.

At least one pivotal connection may be secured to the substructure for attachment of a mast adjacent a rear portion of the pick-up truck bed, whereby the mast is pivotally movable from an upright position to a collapsed position. A track may be defined along the mast and a carriage may be mounted on the track for movement along the track. At least one working attachment may be supported by the carriage to engage the items to be lifted.

The power lifting system may further comprise a gooseneck trailer ball accessible when the mast is in the collapsed position. The mast may comprise two sets of members that are offset from each other to allow access to the gooseneck trailer ball.

The power lifting system may further comprise locking members for locking the carriage in selectable positions along the track as may be especially useful for locking the load into position on the mast.

The power lifting system may further comprise a motor secured to a top portion or other suitable portion of the mast. In one embodiment, a cable for the motor is interconnected with the carriage to move the carriage up and down the track.

The power lifting system may further comprise a plurality of telescoping braces secured between the mast and the substructure. In one embodiment, the plurality of telescoping braces further comprises hydraulic components.

In one possible embodiment, the sub-structure may be secured to the pick-up truck bed with a plurality of fasteners wherein the plurality of fasteners may comprise a plurality of elements such as pins, clamps, bolts, or the like, permanently affixed, e.g., by welding, rivets, or the like, to the pick-up truck bed.

The power lifting system may further comprise at least one weatherproof camera mounted to the substructure to permit easier operational control from within the cab.

The working attachments further comprise at least one hay bale spear or fork lifts. In another embodiment, the working attachments comprise at least one of the following group: hay bale unroller to be used for unrolling cylindrical bales of hay, a man-lift cage to elevate a person or persons and their gear to allow them to perform work, a dump bucket to allow for the transportation and deposit of dirt, a distribution hopper comprised of a bin, a spreader and hydraulic motor to distribute dry materials, and a drilling attachment.

The present invention also comprises a method for providing a powered lifting system, such as in a kit-form or otherwise. The method may comprise steps such as, for instance, providing a substructure securable with respect to the pick-up truck bed and/or sizing and spacing the substructure to permit access to more than 60 percent of the pick-up truck bed when the substructure is secured with respect to the pick-up truck bed.

Other steps might comprise providing a mast pivotally attachable to the substructure, whereby the mast is pivotally movable from an upright position to a collapsed position. The method may comprise providing that the mast defines a track and a carriage mountable on the track for movement along the track. Additionally, the method provides that the carriage supports at least one working attachment to engage the items to be lifted.

### BRIEF DESCRIPTION OF THE DRAWINGS

FIG. 1 is a perspective view taken from a truck cab looking downward and rearward showing a substructure or frame secured to a truck bed in accord with one possible embodiment of the present invention;

FIG. 2 is a perspective view taken from a truck cab looking downward and rearward showing a top view the substructure, as well as a rear view of the vertical track or “mast” upon which the carriage moves in accord with one possible embodiment of the present invention.

FIG. 3 is a perspective view taken from a rear of a truck bed looking towards the truck cab that shows the vertical track or mast complete with the moveable carriage and a winch used to move the carriage in accord with an embodiment of the present invention.

FIG. 4 is a perspective view taken from a truck cab looking downward and rearward showing the present invention as it appears when the mast is collapsed to lay down inside the bed of the truck in accord with one possible embodiment of the present invention.

FIG. 5 is a perspective view taken from a rear of a truck bed looking towards the truck cab that shows an overall view of the invention in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

The present invention provides an apparatus for lifting and/or manipulating a load from the rear of a truck. The apparatus is readily adaptable to any truck without interfering with common functions of the truck. The apparatus is capable of being easily attached and/or removed.

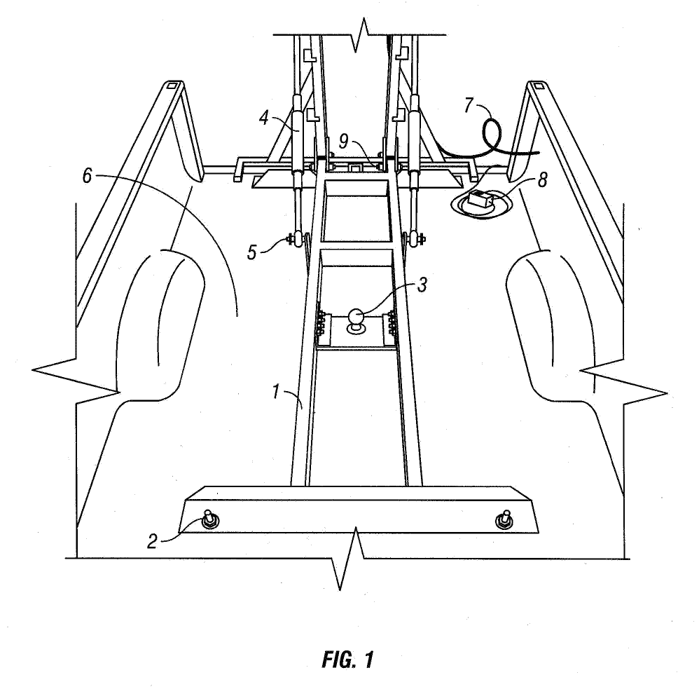

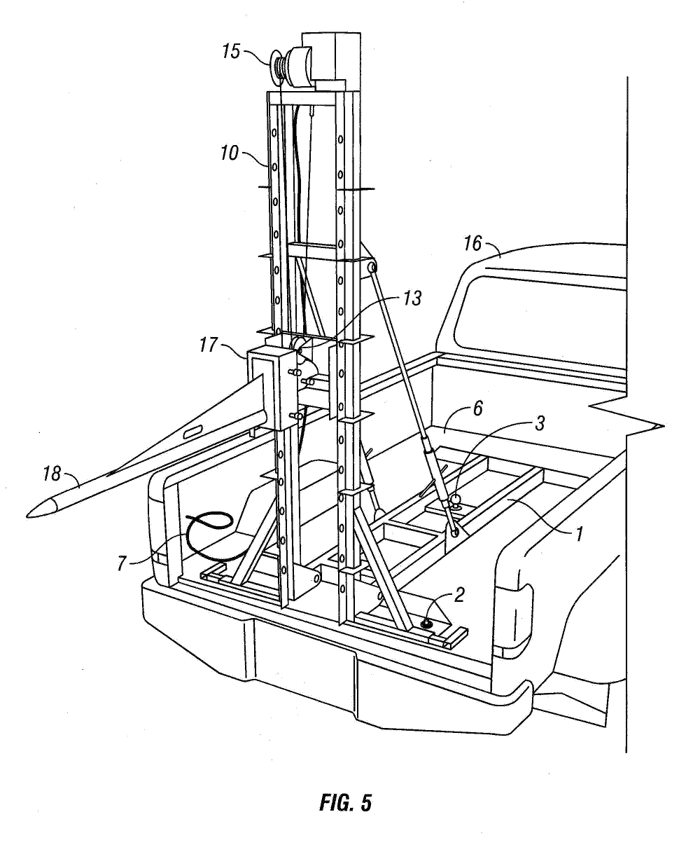

Referring now to the figures, and more particularly to FIGS. 1 and 5, there is shown substructure 1 attached to pick-up truck bed 6 via the substructure mounting 2, which in this case is two (2)¾″ bolts in the rear and two (2)½″ bolts in the front. Substructure 1 may comprise any arrangement of rails, flanges, bars, and the like for securing and supporting the device within pick-up truck bed 6. In one possible embodiment for speedy mounting and removal, substructure 1 may be mounted on pins, bolts, clamps, or other means of reception, a portion of which will be permanently mounted to the frame of the truck. In this way, substructure 1 is mounted in such a way as to allow quick and easy mounting and removal of the invention, yet also allow complete and unobstructed use of the bed when the device is not needed.

In a preferred embodiment, large portions of pick-up truck bed 6 are readily accessible while substructure 1 is mounted to pick-up truck bed 6. In this embodiment substructure 1 is comprised of beams that are sized and spaced apart to permit access to a large portion for pick-up truck bed 6. The floor space of pick-up truck bed 6 not covered by substructure 1 may typically be about 90-95 percent of the pick-up truck bed, and may typically range from about 60 to 98 percent of the pick-up truck bed and preferably be at least about 80-95 percent. The present invention is easily used with truck bed organizers, boxes, or the like. Accordingly, access to a large portion of pick-up truck bed 6 is defined herein according to these ranges of access. This allows other components or features to be available for use as is often highly desirable. Moreover, useful truck-bed components may also be secured to substructure 1 to permit their use. For instance, gooseneck ball 3 may be secured to substructure 1 so that the pick up truck is readily available for towing.

Different configurations of substructure 1 could also be used in order to accommodate various styles of the invention. For example, gooseneck ball 3 as shown here is bolted to substructure 1. However, if an end user already had a gooseneck ball 3 mounted on their truck, this option could be omitted and the present invention allows unobstructed use of the existing gooseneck ball or other mounting system.

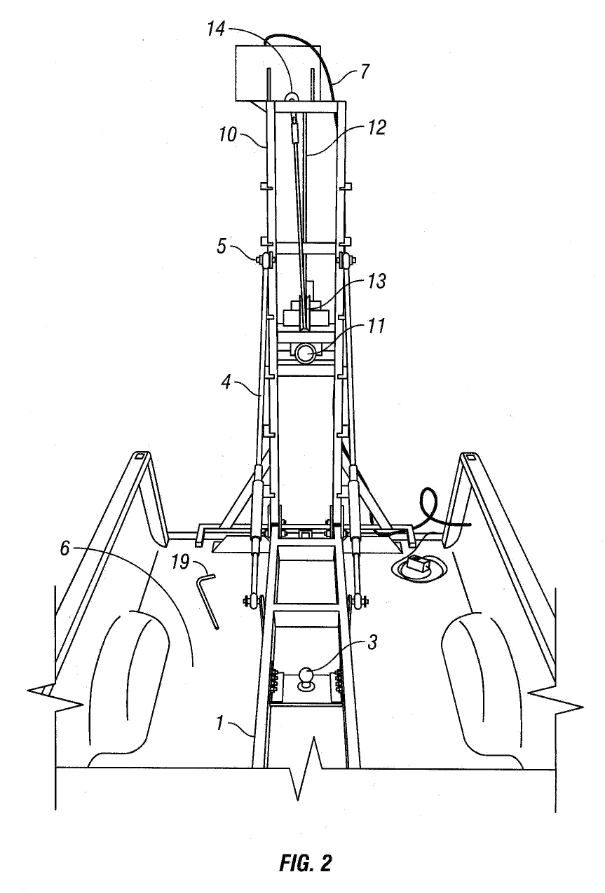

Rail or mast 10 as shown in FIG. 2 may be attached to the substructure 1 by means of a pin or bolt, which can be referred to as the mast pivot point 9 as seen in FIG. 1. In the working position, mast 10 stands upright as seen in FIGS. 1, 2, 3, and 5.

Substructure 1 and mast 10 may be further bound together utilizing braces such as braces 4, which may be attached to mast 10, and substructure 1 via brace attachment pins 5. Braces 4 may be limited in their adjustment and/or easily removed. Braces 4 may be telescoping and comprise pins or the like to fix the length thereof and/or may be of a fixed length. Braces 4 may comprise hydraulic members for shock absorption and/or may extend or retract hydraulically. When mast 10 is upright, then braces 4 are connected at an angle of approximately sixty degrees and may range from about forty to seventy degrees. In one embodiment of the invention, braces 4 may comprise hydraulic cylinders which control movement of mast 10 between a collapsed position and a vertical position and/or adjustment anywhere between.

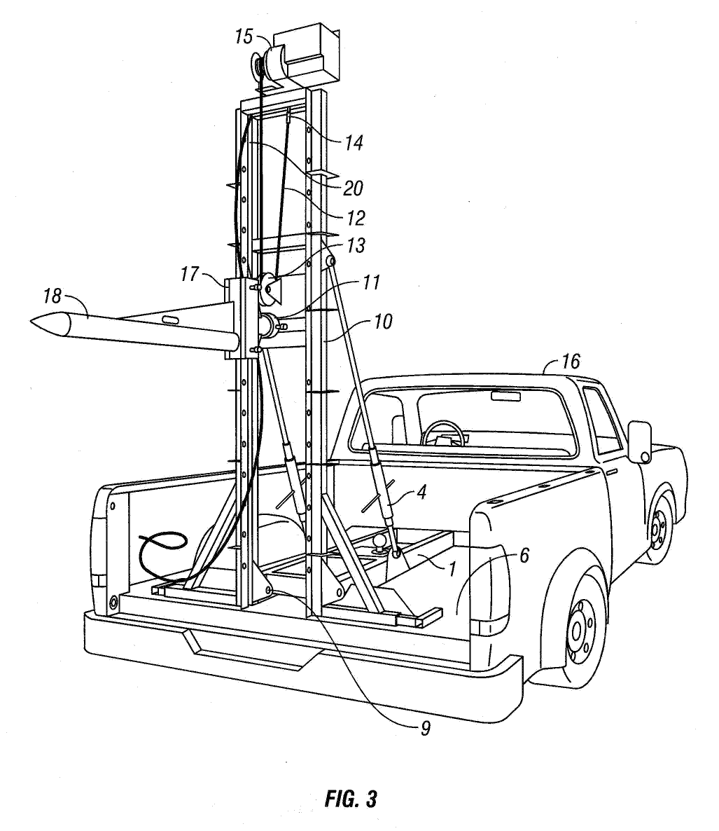

Electric (and/or hydraulic) winch or motor 15 may be mounted to the top of mast 10, as seen in FIG. 3, or positioned as desired on mast 10. In this embodiment, referring to FIG. 3, winch cable 12 extends downwardly from winch or motor 15 around winch cable pulley 13 and back up to the top of the mast 10 where it is attached to the mast via the winch cable hook 14. In this embodiment, winch cable pulley 13 is preferably an integral component to the carriage 11, which rides freely along a track created or defined within mast 10.

Accordingly, carriage 11 may be comprised of winch cable pulley 13, a rigid frame, a socket to accept primary attachments 17 and preferably a plurality of rollers such as, for example, four (4) rollers that allow the carriage to “slide” within the mast 10. In this example, the four rollers may be secured adjacent the four corners of carriage 11.

Primary attachment 17, as seen in FIG. 5, can also readily accept various secondary attachments 18, which allows for smaller, easier to manage attachments. Secondary attachment 18, shown in FIG. 5 may be used as a lifting boom or a hay spear. Other attachments may also be utilized such as pallet forks, rotary drilling attachments for post holes, water wells, horizontal drilling, and the like. Additional attachments may comprise a vehicle recovery platform such as that of a tow-truck, trencher, stump grinder, backhoe, and/or adaptors for 3-point hitch implements or skid-steer implements.

Carriage locking pin 19, as shown in FIG. 2, may be used to lock the carriage 11 in place. Carriage locking pin 19 may be inserted through any of a plurality of locking holes 20 seen along mast 10 in FIG. 3, which correspond with similar holes within the carriage. By locking carriage 11 in a selected position, tension applied by winch or motor 15 may be released, thus saving winch life. Locking of carriage 11 also allows the load to be positioned at a desired position and then carried over any distance to where it is needed. Other locking members such as ratchets, clamps, rods, or the like may also be utilized.

Referring to FIG. 5, winch or motor 15 may be electrically or hydraulically powered through power cable 7. Cable 7 and/or other cables may be directly connected to the electrical system of the host pick-up truck 16 or to appropriate hydraulic cables. Controller 8, as seen in FIG. 1, controls and dictates movement of the winch or motor 15 and thus winch cable pulley 13, carriage 11, primary attachment 17, and secondary attachment 18. Controller 8 may also be hydraulic or electrical.

Although controller 8 is pictured as attached to pick-up truck bed 6, it can also be attached and operated from within the cab of the pick-up truck 16. One or more weather proof cameras may be mounted inside the cab and/or mounted to the substructure to permit easier operational control from within said cab and/or remotely.

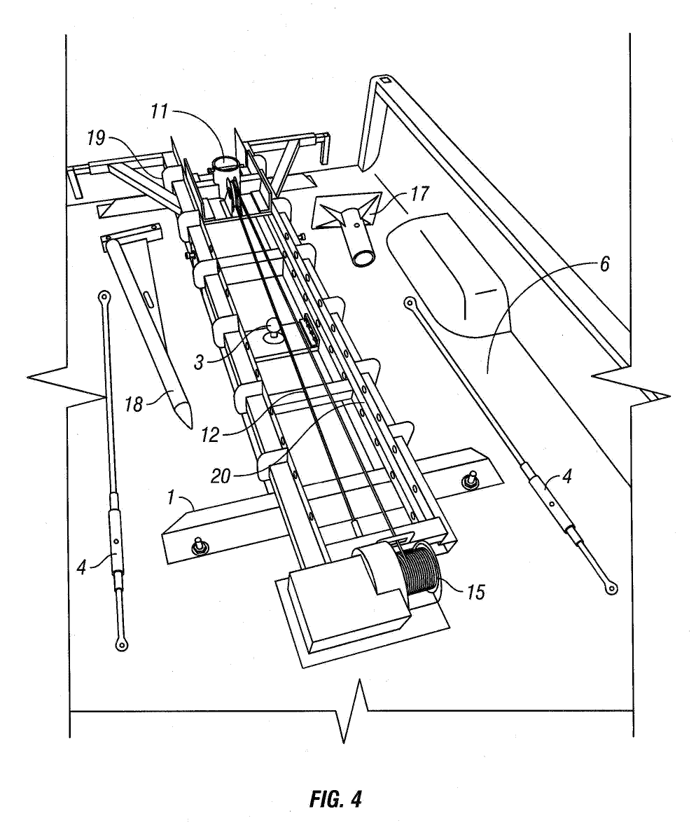

In FIG. 4, the device is shown in a “collapsed” or transport position and many of the components previously mentioned can be seen in their entirety. Had the operator wished to be able to use the gooseneck ball 3, carriage 11 could be placed in another position. In other words, carriage lock pin 19 could be removed, carriage 11 rolled up, and carriage lock pin 19 reinserted into a higher carriage lock pin hole 20 in mast 10, thus locking carriage 11 closer to electric winch or motor 15. This would provide more than adequate space for the use of a gooseneck trailer that could be connected to gooseneck ball 3.

It is important to note that the present invention may also be hydraulically actuated either exclusively, and/or in conjunction with electrical power. Hydraulic operation may be used to improve the number of uses this machine has to offer. As an example, referring to FIG. 3, the braces 4 could be replaced with a pair of hydraulic cylinders and/or adapted to connect to hydraulic cylinders. In one embodiment of the invention, hydraulic cylinders may be used to quickly and conveniently raise and lower the mast 10 and/or adjust the positions of attachments 17 and 18. These cylinders would also make it possible to bring the load inside the pick-up truck bed 6, increasing safety and overall ride of the pick-up truck 16 when transporting a load that is still attached to carriage 11.

Electric winch or motor 15 may be replaced by a hydraulic motor to control carriage 11 by various means, e.g., pistons, chains, sprockets and pins. This new configuration would allow the carriage 11 to not only lift, but also push down. However, two electric motors or a change in pulley/rope configuration may also provide this function.

In conjunction with a hydraulic power, primary attachment 17 lends itself to a multitude of secondary attachments 18, such as an auger, a vertical drill, and/or a horizontal drill that may also be hydraulically powered. Working attachments may also include but are not limited to: (1) hay bale spear(s) with the main purpose of handling bales of hay such as those used for feeding livestock,

(2) a jib crane for the purpose of lifting most anything the end user desires which may include but is not limited to; automobile engines, sick or injured livestock, etc. (3) a hay bale unroller to be used for unrolling cylindrical bales of hay such as those used for feeding livestock. This attachment can be operated either manually or hydraulically using hydraulic cylinders to penetrate the center of the bale, (4) pallet forks to allow handling of palletized materials, (5) a man-lift cage to elevate a person or persons and their gear to allow them to perform work, (6) a dump bucket to allow for the transportation and deposit of dirt or like materials, (7) a brush grapple to allow for safe handling and transportation of bulky materials, (8) a vehicle recovery platform to allow for the safe and efficient transportation of automobiles and/or trucks, and/or (9) a squeezer attachment which will enable specialized handling and transportation of large bales of cotton and/or hay.

These secondary attachments could be used for the purpose of digging post-holes, drilling water wells, drilling small oil and gas exploratory wells, or drilling horizontally, as is a common practice in the utilities industry. The latter of these functions would be used in conjunction with the basic pivotal motion of the vertical track.

In summary, the present invention relates to the use of trucks, pick-up or otherwise, to allow use of said truck for handling, transporting, distributing, loading or unloading a load. It can also be used in a variety of other applications such as drilling. This invention can be used in such industries as, but not limited to, agriculture, manufacturing, oil (and all that implies), transportation, maintenance, utilities, logging, and the like.

The present invention may be electrically or hydraulically operated utilizing the power generated by the truck it has been mounted on, or a separate power unit integral with the device. The motion of carriage 11 of the present invention may be either up and down similar to that of a common fork-lift, or utilizing a combination of pivot points and structural members similar to that of a common tractor mounted front-end loader. The lifting system is also easily collapsed to such a low-profile as to still allow the use of a “gooseneck” trailer ball. The structural member which does the work is manufactured in such a way as to allow the use of multiple attachments such as, but not limited to, hay bale spear, hay bale unroller, pallet forks, man-lift cages, dump bucket, drilling attachment (hydraulic only), or vehicle recovery platform (like that of a tow truck).

The first structural member may be attached to the substructure via a pivot point. The second structural member may be attached to the first structural member via a second pivot point. A terminating structural member is then attached to the second structural member, which may be attached via a third pivot point. The terminating structural member connects two identical sets of structural members and pivot points previously described. All of these structural members may be supported and controlled via a series of hydraulic cylinders.

It should also be noted that the substructure could also be a kit in which the end user attached the necessary connection points required to accept the main lifting system. This option would be most commonly used on vehicles with a flat bed or a “cab and chassis” type frame.

The invention may comprise both straight and articulated lifting systems constructed to accept various attachments, which can be used for a wide variety of work. A small, removable, manual boom could be utilized at the top of the apparatus to assist with manipulating the various attachments. It would also be possible to attach the system with respect to a truck bed by offering a specialized bumper, which would allow faster, safer and stronger attachment of the invention. This specialized bumper would replace the stock bumper and could incorporate outriggers to stabilize the host vehicle for more rigorous work.

Power for the invention may be conveniently supplied via the power generated by the internal combustion engine of the truck to which the lifting system is attached. However, a separate power unit integral with the invention can alternately be used. Electrical power can be supplied in conjunction with additional batteries to provide reserve power to the lifting apparatus. Hydraulic power can be supplied with a hydraulic power unit mounted to the lifting apparatus, or through a hydraulic “wet kit” integral to the truck itself. A hydraulic “wet kit” may consist of a hydraulic motor attached to the internal combustion engine of the truck, hydraulic fluid reservoir, and any necessary hydraulic valves and hoses.

Attachments for the lifting apparatus can be summarized by the following, (but not limited to), hay/cotton bale handler, any and all uses for jib cranes, digging post holes, vehicle recovery, pallet forks, the distribution of dry materials, drilling of wells or horizontal drilling. Other attachments may also include a trencher, mower, backhoe, log splitter, concrete mixer, refuse chipper/mulcher, sprayer, drop hammer, dumping hopper, stump grinder, and/or tree spade. A specialized adapter could also be offered which would allow the use of any three-point hitch attachment or any skid-steer attachment.

One advantage of the main design criteria is to enable access to a “gooseneck” trailer ball within the bed of the truck. This makes the invention very useful in the fact that it can be used to load a trailer, transport the load to a remote location, and unload the trailer all without the use of a tractor, forklift, or any other conventional means of loading or unloading a trailer. It should also be noted that a smaller, lightweight version of the invention could be attached directly to an existing ball, which would virtually eliminate any major modifications to the host vehicle.

Materials of construction would be steel, although various other materials could be offered such as aluminum, stainless steel or high-strength steel. Methods of construction may comprise welding; however, various parts of the invention could be attached via bolts and nuts. This would allow a base apparatus to be offered and the various options could be offered to customize the invention specific to the end users requirements.

Accordingly, the foregoing disclosure and description of the invention is illustrative and explanatory thereof, and it will be appreciated by those skilled in the art, that various changes in the ordering of steps, ranges, and/or attributes and parameters, as well as in the details of the illustrations or combinations of features of the methods and apparatus discussed herein, may be made without departing from the spirit of the invention.

What is claimed is:

1. A power lifting system for a pick-up truck to engage items to be lifted, said pick-up truck comprising a pick-up truck bed with a rear portion and a front portion, said pick-up truck comprising a cab adjacent said front portion of said pick-up truck bed, said power lifting system comprising:
a sub-structure comprising a plurality of beams securable with respect to said pick-up truck bed so as to be removable, said plurality of beams being sized and spaced apart to permit access to a more than sixty percent of said pick-up truck bed when said sub-structure is secured with respect to said pick-up truck bed;
at least one pivotal connection secured to said substructure;
a mast attached to said at least one pivotal connection adjacent a rear portion of said pick-up truck bed whereby said mast is pivotally movable from an upright position to a collapsed position;
a track defined along said mast;
a carriage mounted on said track for movement along said track; and
at least one working attachment for said carriage to engage said items to be lifted.

2. The power lifting system of claim 1 further comprising a gooseneck trailer ball accessible when said mast is in said collapsed position.

3. The power lifting system of claim 2 wherein said mast comprises two sets of members that are offset from each other to allow access to said gooseneck trailer ball.

4. The power lifting system of claim 1 further comprising locking members for locking said carriage in selectable positions along said track.

5. The power lifting system of claim 1 further comprising a motor secured to a top portion of said mast, a cable for said motor interconnected with said carriage to move said carriage up and down said track.

6. The power lifting system of claim 1 further comprising a plurality of telescoping braces secured between said mast and said substructure.

7. The power lifting system of claim 6 further wherein said plurality of telescoping braces further comprise hydraulic components.

8. The power lifting system of claim 1 wherein said sub-structure is secured to said pick-up truck bed with a plurality of fasteners, said plurality of fasteners comprising a plurality of elements permanently affixed to said pick-up truck bed.

9. The power lifting system of claim 1 further comprising at least one weather proof camera mounted to said substructure to permit easier operational control from within said cab of said pick-up truck.

10. The power lifting system of claim 1 wherein said working attachments further comprise at least one hay bale spear.

11. The power lifting system of claim 1 wherein said working attachments comprise at least one of the following group: hay bale unroller to be used for unrolling cylindrical bales of hay, a man-lift cage to elevate a person or persons and their gear to allow them to perform work, a dump bucket to allow for the transportation and deposit of dirt, a distribution hopper comprised of a bin, a spreader and hydraulic motor to distribute dry materials, and a drilling attachment.

12. A method for providing a powered lifting system for a pick-up truck to engage items to be lifted, said pick-up truck comprising a pick-up truck bed with a rear portion and a front portion, said pick-up truck comprising a cab adjacent said front portion of said pick-up truck bed, said method comprising:
providing a substructure securable with respect to said pick-up truck bed;
sizing and spacing said substructure to permit access to more than 60 percent of said pick-up truck bed when said substructure is secured with respect to said pick-up truck bed;
providing a mast pivotally attachable to said substructure whereby said mast is pivotally movable from an upright position to a collapsed position;
providing that said mast defines a track;
providing a carriage mountable on said track for movement along said track; and
providing that said carriage supports at least one working attachment to engage said items to be lifted.

13. The power lifting system of claim 12 further comprising providing access to a gooseneck trailer ball when said mast is in said collapsed position.

14. The power lifting system of claim 13 further providing that said mast comprises two sets of members that are offset from each other to allow access to said gooseneck trailer ball.

15. The power lifting system of claim 12 further comprising providing a locking mechanism for locking said carriage in a selectable position along said track.

16. The power lifting system of claim 12 further comprising providing a motor to move said carriage up and down said track.

17. The power lifting system of claim 12 further comprising providing a plurality of telescoping braces secured between said mast and said substructure.

18. The power lifting system of claim 17 further comprising providing hydraulic elements for said plurality of braces.

19. The power lifting system of claim 12 further comprising providing that said working attachments further comprise at least one hay bale spear.

20. The power lifting system of claim 12 further comprising providing that said working attachments comprise at least one of the following group: a dump bucket to allow for the transportation and deposit of dirt, a distribution hopper comprised of a bin, a spreader and hydraulic motor to distribute dry materials, and a drilling attachment.
